(19) United States
(12) Patent Application Publication
(10) Pub. No.: US 2012/0056890 A1
(43) Pub. Date: Mar. 8, 2012

(54) FLEXIBLE FILM INTERFEROMETRIC MODULATOR DEVICES AND METHODS OF FORMING THE SAME

(75) Inventor: Marc M. Mignard, San Jose, CA (US)

(73) Assignee: QUALCOMM MEMS Technologies, Inc., San Diego, CA (US)

(21) Appl. No.: 13/217,033

(22) Filed: Aug. 24, 2011

Related U.S. Application Data
(60) Provisional application No. 61/379,691, filed on Sep. 2, 2010.
(60) Provisional application No. 61/379,697, filed on Sep. 2, 2010.

(51) Int. Cl. G06T 1/00; B32B 38/08; B44C 1/17; G02B 26/00

(52) U.S. Cl. 345/501; 359/291; 359/290; 156/182; 156/719; 156/234

(57) ABSTRACT

The present disclosure provides systems, methods and apparatus for providing interferometric modulator displays using flexible films. In one aspect, a method of forming an interferometric modulator device includes providing a conductive element, depositing a reflective layer over at least a portion of the conductive element, and depositing a plurality of spacing elements over the conductive element. The absorber layer and the substrate are provided over the conductive element such that the absorber layer is disposed between the substrate and the spacing elements.

### CROSS-REFERENCE TO RELATED APPLICATIONS

The disclosure claims priority to U.S. Provisional Patent Application No. 61/379,691 filed Sep. 2, 2010 entitled “INTERFEROMETRIC MODULATOR DEVICES AND METHOD OF FORMING THE SAME,” and to U.S. Provisional Patent Application No. 61/379,697 filed Sep. 2, 2010 entitled “INTERFEROMETRIC MODULATOR DEVICES AND METHOD OF FORMING THE SAME,” each of which is assigned to the assignee hereof. The disclosures of the prior applications are considered part of, and are incorporated by reference in, this disclosure.

### TECHNICAL FIELD

This disclosure relates to electromechanical systems.

### DESCRIPTION OF THE RELATED TECHNOLOGY

Electromechanical systems (EMS) include devices having electrical and mechanical elements, actuators, transducers, sensors, optical components (including mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Some products include segmented displays having segments that can be selectively controlled to display alphanumeric and graphic characters. Segmented displays can include a patterned substrate, such as a printed circuit board (“PCB”) patterned to form the segments. The voltage potential of the segments of the PCB can be dynamically adjusted to form segmented images. Segmented displays can be relatively inexpensive to manufacture, and can have relative low dynamic power consumption.

### SUMMARY

The systems, methods and devices of the disclosure each have several innovative aspects, no single one of which is solely responsible for the desirable attributes disclosed herein.

One innovative aspect of the subject matter described in this disclosure can be implemented in a device including a plurality of display elements, each element including a conductive element, a flexible film including a partially reflective and partially transmissive absorber layer, and a reflective layer disposed on the conductive element. The reflective layer is disposed at least partially between the flexible film and the conductive element, and the reflective layer and the absorber layer define a cavity therebetween. The flexible film is configured to move toward the conductive element when a voltage is applied across the flexible film and the conductive element due to an electrostatic force generated between the flexible film and the conductive element.

Another innovative aspect of the subject matter described in this disclosure can be implemented in a device including a flexible absorber layer, a printed circuit board including at least one conductive trace element, and a reflective layer disposed over the conductive trace element. The absorber layer is partially reflective and partially transmissive, and the flexible absorber layer is configured to move toward the printed circuit board when a voltage is applied between the absorber layer the conductive trace element. Movement of the absorber layer alters the optical characteristics of the display device.

Another innovative aspect of the subject matter described in this disclosure can be implemented in a device including a display means. The display means includes means for applying a voltage, flexible means for partially reflecting and transmitting light, and means for reflecting light disposed on the voltage applying means. The reflective means is disposed at least partially between the flexible means and the voltage applying means, and the reflective means and the flexible means define a cavity therebetween. The flexible means is configured to move toward the voltage applying means when a voltage is applied between the flexible means and the voltage applying means.

Another innovative aspect of the subject matter described in this disclosure can be implemented in a method of manufacturing a device. The method includes depositing an absorber layer on a sacrificial material, providing a substrate, depositing a first adhesive layer on the substrate, depositing a second adhesive layer on the substrate, positioning the absorber layer over the first and second adhesive layers such that the absorber layer contacts the first and second adhesive layers, and developing the adhesive layer. The absorber layer includes a partially reflective and transmissive material. The first adhesive layer and the second adhesive layer are substantially co-planar and are spaced apart from one another on a common plane.

Another innovative aspect of the subject matter described in this disclosure can be implemented in a method of manufacturing a device. The method includes providing a substrate, depositing an adhesive inhibiting material on the substrate, depositing an absorber layer over the adhesive inhibiting material, providing an electrode, and applying a voltage between the absorber layer and the electrode to pull a portion of the absorber layer away from the substrate. The absorber layer includes a partially reflective and transmissive material.

Details of one or more implementations of the subject matter described in this specification are set forth in the accompanying drawings and the description below. Although the examples provided in this disclosure are primarily described in terms of EMS and MEMS-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example of an isometric view depicting two adjacent pixels in a series of pixels of an interferometric modulator (IMOD) display device.

FIG. 1B shows an example of a system block diagram illustrating an electronic device incorporating a 3×3 interferometric modulator display.

FIGS. 2-6 show examples of cross-sectional schematics illustrating varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a schematic cross section of an interferometric stack.

FIG. 9B shows a graph of brightness versus gap size for one example of an interferometric stack.

FIG. 9C shows a graph of reflectivity spectrum versus wavelength for three examples of interferometric stacks.

FIG. 10 shows an example of a flow diagram illustrating a manufacturing process for an interferometric modulator.

FIG. 11 shows an example of a schematic plan view of a segmented display.

FIG. 12 shows an example of a flow diagram illustrating a manufacturing process for an interferometric modulator.

FIGS. 13A-13G show examples of cross-sectional schematic illustrations of various stages in methods of making interferometric modulators according to various implementations.

FIG. 14 shows an example of a flow diagram illustrating a manufacturing process for an interferometric modulator.

FIGS. 15A-15I show examples of cross-sectional schematic illustrations of various stages in methods of making interferometric modulators according to various implementations.

FIG. 16 shows an example of a flow diagram illustrating a manufacturing process for an interferometric modulator.

FIGS. 17A-17F show examples of cross-sectional schematic illustrations of various stages in methods of making interferometric modulators according to various implementations.

FIGS. 18A and 18B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, an interferometric modulator device is disclosed having a relatively large gap height such that the device includes multiple optical resonances and reflects lights appearing to a viewer as substantially white. The device can include an optically resonant cavity having a dielectric of a relatively high index of refraction, thereby broadening optical peaks in the reflectance spectrum and increasing the brightness of the reflected light. The device can have improved tolerance to variation in air gap height, thereby providing improved color consistency across a display and permitting manufacturing of the devices using relatively inexpensive processes, such as printed circuit board (PCB) technology.

In some implementations, an interferometric modulator device is disclosed having a stationary electrode formed from a patterned conductive layer on a substrate, such as a PCB. A reflective layer can be disposed on the patterned conductive layer, and a flexible film having an optical stack can be spaced from the patterned substrate to define a gap. The resulting interferometric modulator devices can be manufactured inexpensively and can be used in a direct-drive segmented display, thereby eliminating a need for row and column switching and reducing power consumption. In some implementations, the interferometric modulator devices can have multiple optical resonances and can reflect light appearing to a viewer as substantially white. For example, some interferometric modulator devices described herein can include a relatively large gap height, such as gap heights greater than about 1000 nm. By configuring the device in this manner, a display can be provided that includes interferometric modulator devices having improved tolerance to variation in air gap height and having improved color consistency across the display. Additionally, in some implementations, a dielectric layer of the optical stack can have a relatively high index of refraction, such as an index of refraction greater than about 2.0 to aid in enhancing the brightness of the display.

Particular implementations of the subject matter described in this disclosure can be implemented to realize one or more of the following potential advantages. For examples, some implementations provide displays that are relatively inexpensive to manufacture and can be employed in direct-drive segmented displays. Additionally, some implementations can reduce power consumption. Furthermore, some implementations provide displays that can reflect light appearing to a viewer as substantially white. Moreover, some implementation can be used to enhanced brightness of a display and/or improve a displays tolerance to variation in air gap height.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

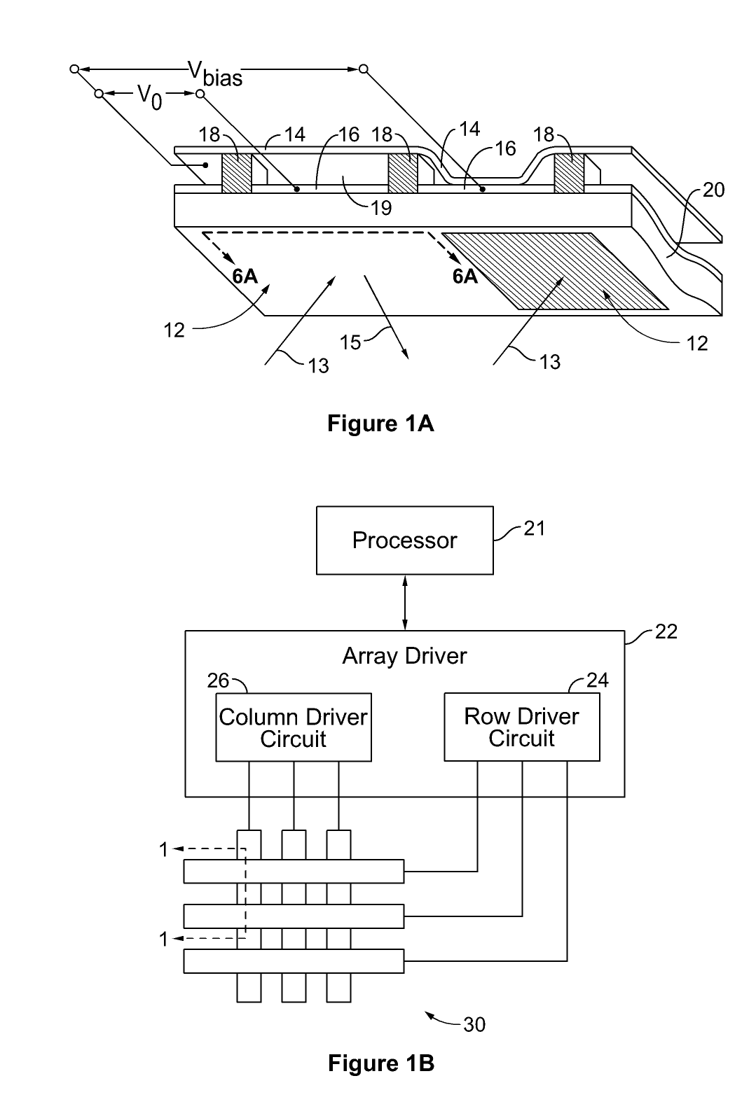

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1A includes two adjacent interferometric modulators 12 (i.e., IMOD pixels). In the IMOD pixel 12 on the left (as illustrated), a movable reflective layer 14 is illustrated in a relaxed position at a distance (which may be predetermined based on design parameters) from an optical stack 16, which includes a partially reflective layer. The voltage V₀ applied across the IMOD pixel 12 on the left is insufficient to cause actuation of the movable reflective layer 14. In the IMOD pixel 12 on the right, the movable reflective layer 14 is illustrated in an actuated position near, adjacent or touching the optical stack 16. The voltage V_{bias} applied across the IMOD 12 on the right is sufficient to move and can maintain the movable reflective layer 14 in the actuated position.

In FIG. 1A, the reflective properties of pixels 12 are generally illustrated with arrows 13 indicating light incident upon the pixels 12, and light 15 reflecting from the IMOD pixel 12 on the left. A person having ordinary skill in the art will readily recognize that most of the light 13 incident upon the pixels 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1A, with the gap 19 between the movable reflective layer 14 and optical stack 16. However, when a potential difference, i.e., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1A. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 1B shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1A is shown by the lines 1-1 in FIG. 1B. Although FIG. 1B illustrates a 3×3 array of IMODs for the sake of clarity, the display array 30 may contain a very large number of IMODs, and may have a different number of IMODs in rows than in columns, and vice versa.

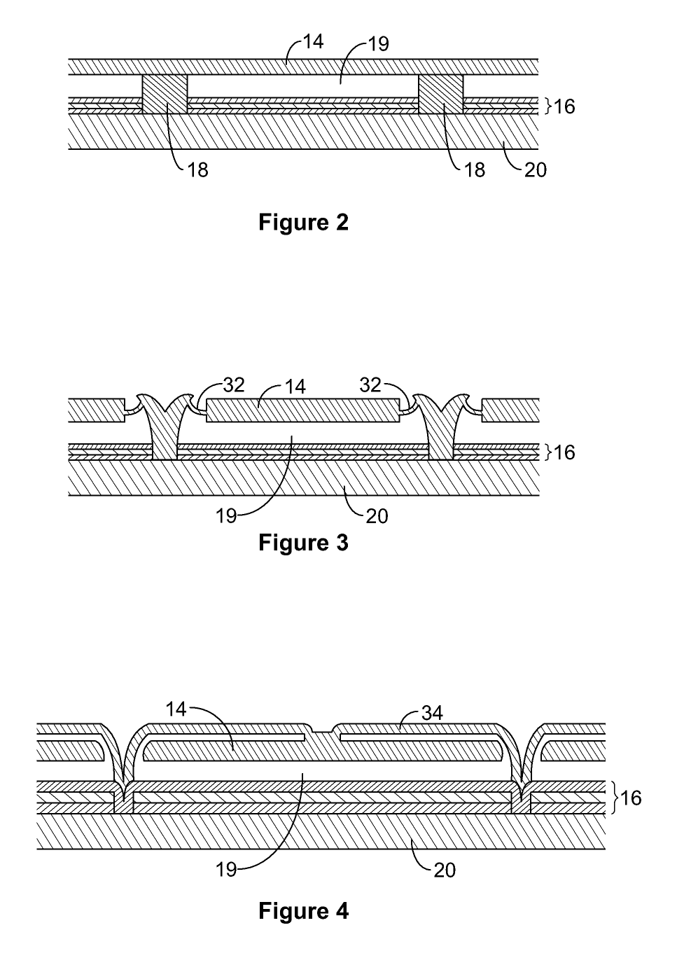

The details of the structure of interferometric modulators that operate in accordance with the principles set forth above may vary widely. For example, FIGS. 2-6 show examples of cross-sections of varying implementations of interferometric modulators, including the movable reflective layer 14 and its supporting structures. FIG. 2 shows an example of a partial cross-section of the interferometric modulator display of FIG. 1A, where a strip of metal material, i.e., the movable reflective layer 14 is deposited on supports 18 extending orthogonally from the substrate 20. In FIG. 3, the movable reflective layer 14 of each IMOD is generally square or rectangular in shape and attached to supports at or near the corners, on tethers 32. In FIG. 4, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 4 has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

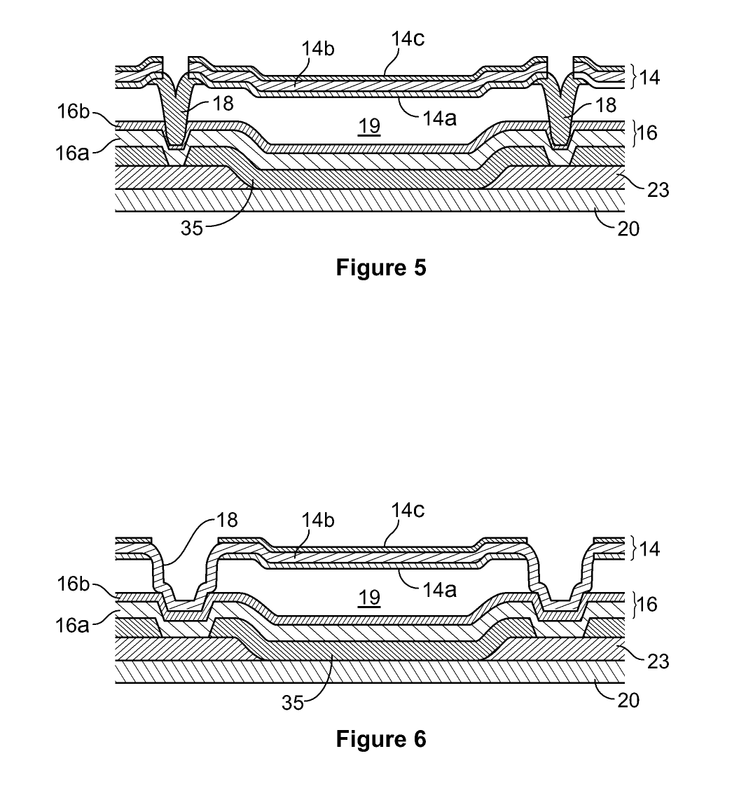

FIG. 5 shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 5, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a silicon dioxide (SiO₂) layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6 shows another example of an IMOD, where the movable reflective layer 14 is self supporting. In contrast with FIG. 5, the implementation of FIG. 6 does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6 when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 2-6, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 4) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 2-6 can simplify processing, such as patterning.

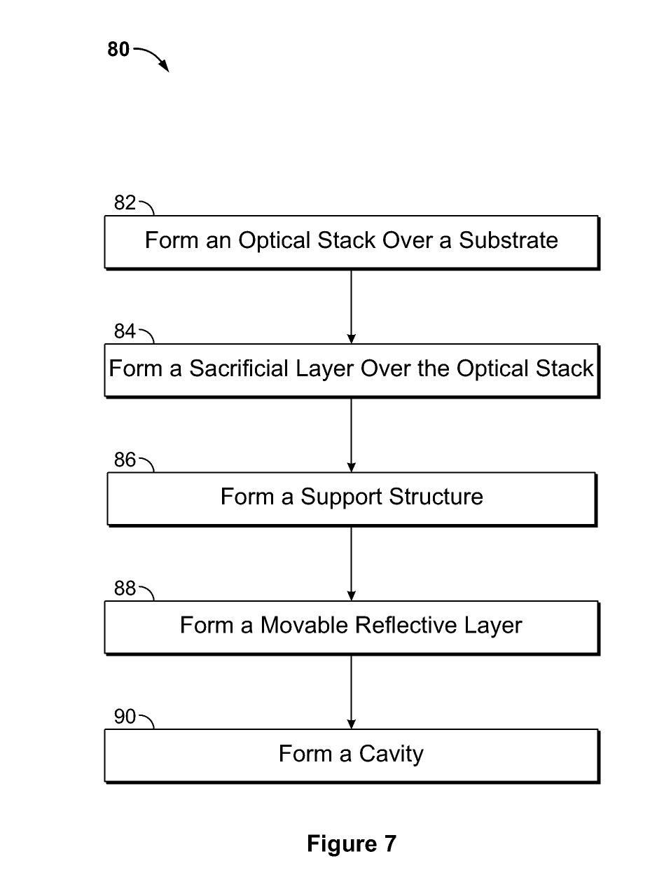

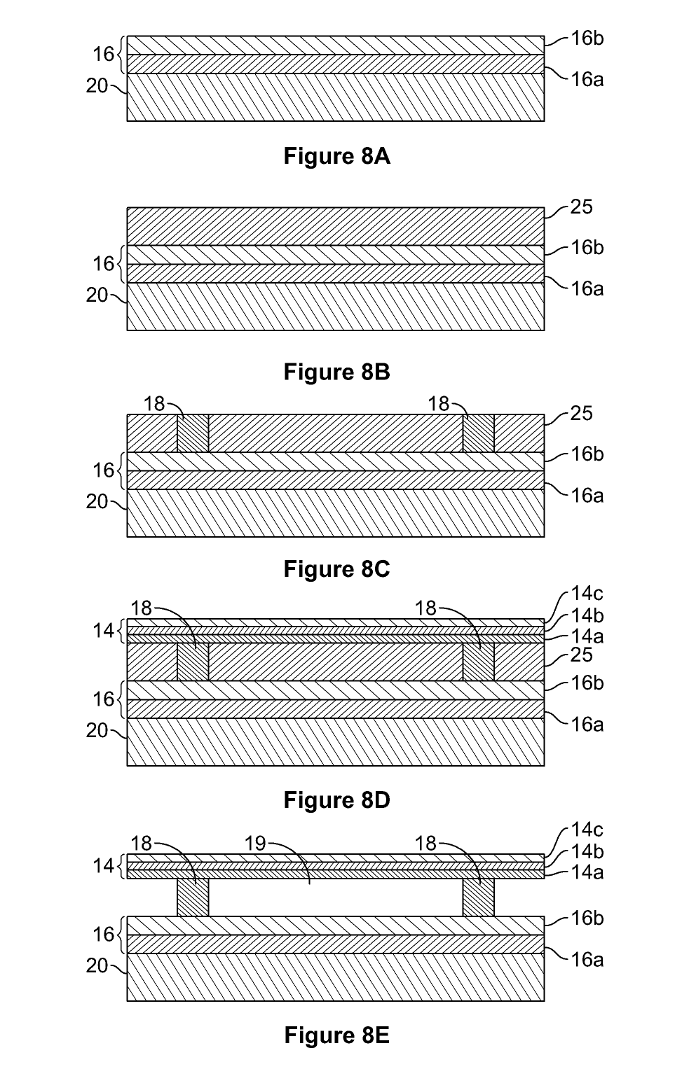

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1A and 2-6, in addition to other blocks not shown in FIG. 7. With reference to FIGS. 1A and 2-7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In the implementation illustrated in FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1A. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1A and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1A, 5 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 2. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1A, 2-6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1A, the movable reflective layer 14 can be patterned into individual and parallel strips that form the columns of the display.

The process 80 continues at block 90 with the formation of a cavity, e.g., cavity 19 as illustrated in FIGS. 1A, 2-6 and 8E. The cavity 19 may be formed by exposing the sacrificial material 25 (deposited at block 84) to an etchant. For example, an etchable sacrificial material such as molybdenum (Mo) or amorphous silicon (Si) may be removed by dry chemical etching, e.g., by exposing the sacrificial layer 25 to a gaseous or vaporous etchant, such as vapors derived from solid xenon difluoride (XeF₂) for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

In some implementations described herein, a display is provided that includes interferometric modulator devices having improved tolerance to variation in air gap height and having improved color consistency across the display. The interferometric modulator devices can have multiple optical resonances and can reflect light appearing to a viewer as substantially white. In some implementations, the interferometric modulator devices can have enhanced brightness and can be manufactured at reduced cost.

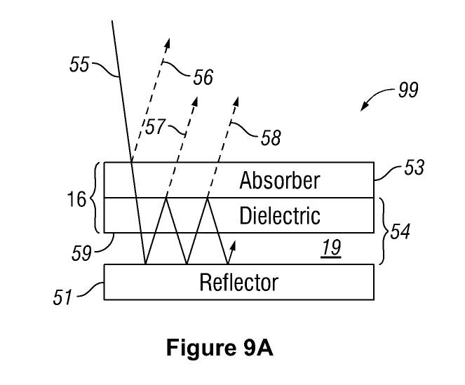

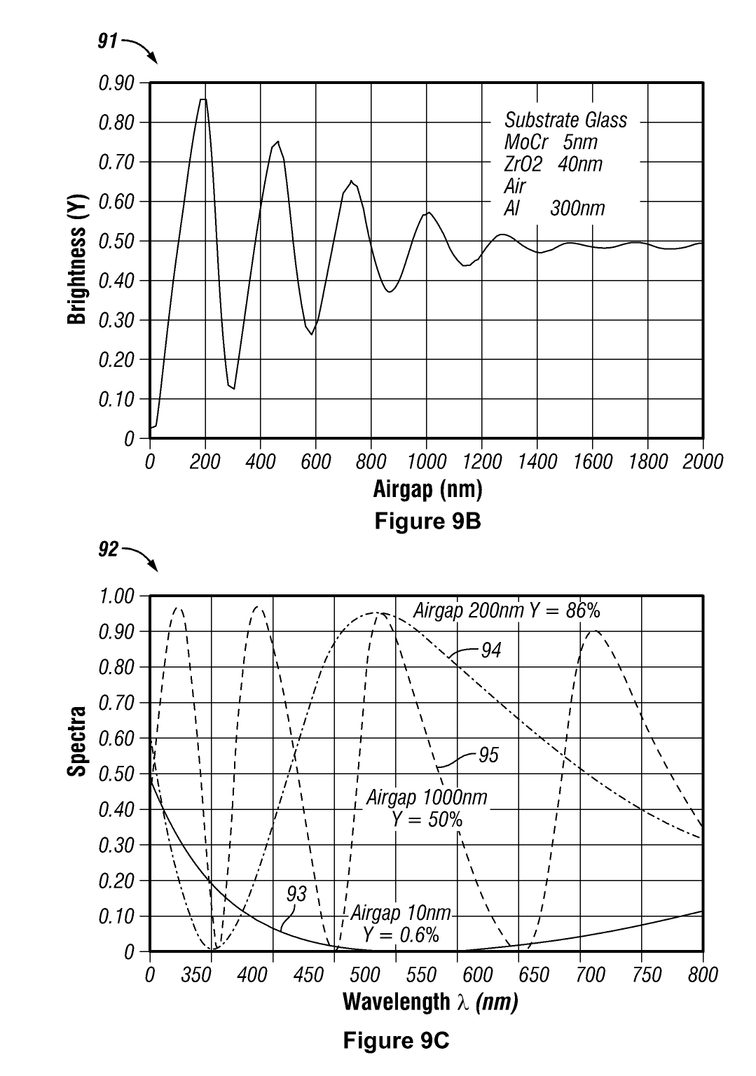

FIG. 9A shows an example of a schematic cross section of an interferometric stack 99. The interferometric stack 99 can form a portion of an interferometric modulator, and includes an optical stack 16, a gap 19, and a reflector 51. The optical stack 16 can include a dielectric 59 and a partially reflective optical absorber 53, such as chromium (Cr). By positioning the dielectric 59 and the gap 19 between the optical absorber 53 and the reflector 51, an optically resonant cavity 54 having a desired thickness or “thickness dimension” can be formed, as will be described below. As used herein in relation to the optical cavity, the term “thickness,” and also “thickness dimension,” refer to the distance between the two reflective surfaces that are on either side of the optically resonant cavity 54. In various implementations, the thickness (or thickness dimension) can include the thickness of the dielectric and the thickness of the gap that are included in an optical cavity. For example, in the configuration illustrated in FIG. 9A, the thickness dimension is the distance between the absorber 53 and the reflector 51 and includes the thickness of the gap 19 and the dielectric 59. Although not illustrated in FIG. 9A, the optical stack 16 also can include a transparent conductor, such as indium tin oxide (ITO), which can serve as an electrode to pull the reflector 51 and the optical stack 16 together (using electrostatic forces) when the stack is employed in an interferometric modulator device.

When incident light 55 reaches the interferometric stack 99, a portion of the light 55 can be reflected off of the partially reflective optical absorber 53, thereby forming a first reflected portion of light 56. Additionally, as shown in FIG. 9A, some of the light passes through the absorber 53 and the dielectric 59 and can enter the optically resonant cavity 54 and reach the reflector 51, where it is reflected back to the partially reflective optical absorber 51. A first portion of light incident upon the optical absorber 51 from within the optically resonant cavity can exit the cavity to form a second portion of reflected light 57, while some light can remain within the optically resonant cavity 54. Each time light within the optically resonant cavity 54 reaches the partially reflective optical absorber 53, a portion of the light can exit the cavity and a portion of the light can remain in the optically resonant cavity and can be reflected by the reflector 51 one or more times thereafter. Depending on the height of the gap 19, the wavelength of the light 55, and the thickness and index of refraction of the dielectric 59, phase differences can exist between the first portion of light 56 and the portions of light exiting the optically resonant cavity, such as the second and third portions of light 57, 58. Based on these phase differences, some wavelengths of the light 55 can constructively interfere, while other wavelengths of the light can destructively interfere.

In some implementations of interferometric modulator devices, the gap height and dielectric 59 are selected so that the interferometric stack 99 has a single optical resonance in the visible band of light. The wavelength of the optical resonance and the brightness of the reflected light can vary significantly with the height of the gap 19, and thus it can be important to tightly control gap height variation. Control of the gap height can be difficult, for example, in implementations in which the gap 19 is formed by removing a sacrificial layer. For example, mechanical stresses in the reflector 51 can produce unintended variation in the gap size after removal of the sacrificial material. Additionally, temperature changes can cause variation in gap height.

In some implementations, an interferometric modulator device is configured with a large gap size such that the reflectivity spectrum includes multiple color peaks. Additionally, the optical stack 16 is selected such that the optical resonances of the interferometric stack 99 extend over a relatively wide range of wavelengths in the spectrum of visible light, thereby reflecting light which appears substantially white to a viewer. Furthermore, a dielectric having a relatively high index of refraction, such as an index greater than or equal to about 2.0, can be employed to increase the brightness of the reflected light. Employing a dielectric having a relatively high index of refraction can result in the interferometric stack reflecting light having a relatively greater brightness as compared to an interferometric stack using a dielectric having a relatively low index of refraction. Since the interferometric stack can be configured to have a plurality of optically resonant peaks within the band of visible light, the plurality of optical peaks can reflect light which appears substantially white to a user.

Accordingly, employing an interferometric modulator device having a relatively large gap height and a dielectric 59 of a relatively high index of refraction can produce a device which can reflect light appearing to be substantially white and which has an increased brightness. Additionally, as will be described in further detail below, the interferometric modulator device can reflect light which appears to be white over a relatively wide range of gap values, thereby increasing the tolerance of the interferometric modulator device to gap variation and permitting the device to be manufactured using relatively low-cost manufacturing processes.

FIG. 9B shows a graph 91 of brightness versus gap size for one example of an interferometric stack. The graph 91 shows simulation results for an interferometric stack including a partially reflective optical absorber of molybdenum chromium (MoCr) having a thickness of about 5 nm, a zirconium dioxide (ZrO₂) dielectric layer having a thickness of about 40 nm, and an aluminum (Al) reflective layer having a thickness of about 300 nm. Although the graph 91 illustrates a configuration in which the substrate is glass, skilled artisans will appreciate that the results can be similar for a variety of substantially transparent substrates, including plastic substrates.

As shown in the graph 91, the brightness of the simulated interferometric stack becomes less sensitive to variation in gap height as the magnitude of the height increases. Thus, in contrast to an interferometric modulator device having a gap height of about 200 nm, an interferometric modulator device having a relatively large gap height, including, for example, gap heights greater than about 1000 nm, exhibits substantially less variation in brightness for a particular variation in gap height size. Thus, interferometric modulator devices employing a relatively large gap height can be manufactured using processes having a lower precision. These processes can be cheaper than processes designed for smaller tolerances, resulting in a decreased cost for a display employing these interferometric modulators.

FIG. 9C shows a graph 92 of reflectivity spectrum versus wavelength for three examples of interferometric stacks. The graph 92 shows simulation results for an interferometric stack including a partially reflective optical absorber of MoCr having a thickness of about 5 nm, a ZrO₂ dielectric layer having a thickness of about 40 nm, and an Al reflective layer having a thickness of about 300 nm over a glass substrate.

The graph 92 illustrates interferometric stacks for three gap heights. In particular, a first plot 93 illustrates an interferometric stack having a gap height of about 10 nm, a second plot 94 illustrates an interferometric stack having a gap height of about 200 nm, and a third plot 95 illustrates an interferometric stack having a gap height of about 1000 nm. As shown by a comparison of the first plot 93, the second plot 94, and the third plot 95 increasing the gap height results in the interferometric stack having a plurality of optical resonances and a plurality of reflectivity spectrum peak wavelengths. The multitude of optical resonances over the band of visible light can result in a reflectance spectrum which produces reflected light that can appear to be substantially white to a viewer. Additionally, the variation in perceived color can vary less than that of a display with a single optical resonance positioned at a single wavelength of light. Furthermore, by selecting the index of refraction to be relatively large, the optical peaks can cover a relatively broader range of wavelengths, which can result in improved brightness. Accordingly, using a relatively large gap height and a dielectric having a relatively high index of refraction in an interferometric modulator device can improve tolerance to gap height variation and can improve the brightness of a display employing the devices.

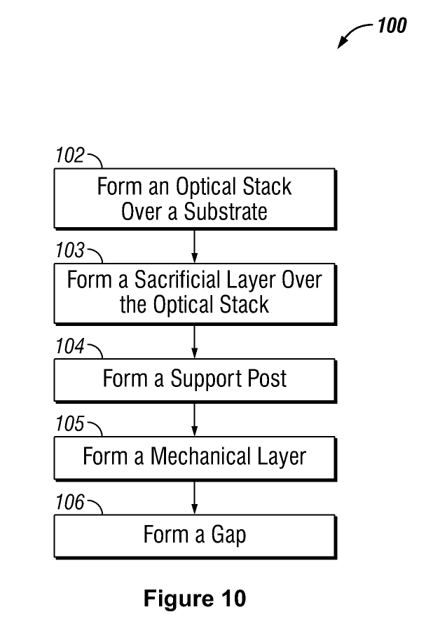

FIG. 10 shows an example of a flow diagram illustrating a manufacturing process for an interferometric modulator. With reference to FIGS. 2-6, 9A and 10, the process 100 starts at block 102, in which a stationary electrode such as the optical stack 16 is formed over the substrate 20. The substrate 20 can be, for example, a transparent substrate including glass or a transparent polymeric material which permits images to be viewed through the substrate. Although the process 100 is illustrated as starting at block 102, the substrate 20 can be subjected to one or more prior preparation steps such as, for example, a cleaning step to facilitate efficient formation of the optical stack 16. Additionally, in some implementations one or more layers are provided before forming the optical stack 16 over the substrate 20. For example, with reference to FIG. 6, in some configurations the black mask 23 is provided before forming the optical stack 16.

The optical stack 16 can include an optional transparent conductor, a partially reflective optical absorber layer 53, and a transparent dielectric 59. In some implementations, the absorber layer 53 can include molybdenum (Mo), chromium (Cr), tungsten (W), vanadium (V), silicon (Si), germanium (Ge), tantalum (Ta), or osmium (Os), and can have, for example, a thickness in the range of about 3 nm to about 20 nm. The transparent dielectric 59 can be configured to include a material having a relatively high index of refraction, such as zirconium dioxide (ZrO₂), titanium dioxide (TiO₂), hafnium dioxide (HfO₂), silicon nitride (Si₃N₄), silicon oxynitride (SiON), yttrium oxide (Y₂O₃), gallium nitride (GaN), gallium phosphide (GaP), and/or nanocrystalline diamond. In some implementations the index of refraction is selected to be greater than or equal to about 2.0, or more particularly, greater than or equal to about 2.4. Inclusion of a dielectric 59 having a relatively high index of refraction can increase the brightness of the display. In some implementations, the thickness (or thickness dimension) of the dielectric 59 can be selected to be in the range of about 20 nm to about 50 nm.

The process 100 illustrated in FIG. 10 continues to a block 103, in which a sacrificial layer is formed over the optical stack 16. The sacrificial layer is later removed to form a gap (e.g., 19 of FIG. 9A). The formation of the sacrificial layer over the optical stack 16 may include deposition of a fluorine-etchable material such as molybdenum (Mo) or amorphous silicon (a-Si), in a thickness selected to provide, after subsequent removal, a gap 19 having the desired size. In some implementations, the gap size is selected to be in the range of about 1000 nm to about 10 μm.

The process 100 illustrated in FIG. 10 continues at block 104 with the formation of a support structure, such as the support post 18 illustrated in FIG. 5. The formation of the support post 18 may include the steps of patterning the sacrificial layer to form a support structure aperture, then depositing a material (such as a polymer or a silicon oxide) into the aperture using a deposition method such as PECVD, thermal CVD, or spin-coating. In some implementations, the support structure aperture formed in the sacrificial layer extends through both the sacrificial layer and the optical stack 16 to the underlying substrate 20, so that the lower end of the support post 18 contacts the substrate 20. In some other implementations, the aperture formed in the sacrificial layer extends through the sacrificial layer, but not through the optical stack 16.

The process 100 illustrated in FIG. 10 continues at block 105 with the formation of a mechanical layer such as the mechanical layer 14 illustrated in FIG. 5. The mechanical layer 14 can be formed by employing one or more deposition steps, e.g., reflective layer (such as aluminum, aluminum alloy) deposition, along with one or more patterning, masking, and/or etching steps. As discussed above, the mechanical layer can be electrically conductive, and in some implementations may serve as the movable electrode. Since the sacrificial layer is still present in the partially fabricated interferometric modulator formed at block 105 of the process 100, the mechanical layer 14 is typically not movable at this stage.

The process 100 illustrated in FIG. 10 continues at block 106 with the formation of a gap, e.g., the gap 19 illustrated in FIG. 9A. The gap 19 may be formed by exposing the sacrificial material, such as the sacrificial material deposited at the block 103, to an etchant. For example, a sacrificial material such as molybdenum (Mo), tungsten (W), tantalum (Ta) or polycrystalline silicon (poly-Si) or amorphous silicon (a-Si) can be removed by etching. The sacrificial layer can be exposed for a period of time that is effective to remove the material, typically selectively relative to the structures surrounding the gap 19. Since the sacrificial layer is removed during block 106 of the process 100, the movable reflective layer 14 is released at this stage.

The process above can be used for manufacturing, for example, interferometric modulators having improved brightness and robustness to gap height variation. The interferometric modulators can be used, for example, in black and white displays, or in analog interferometric modulator implementations. Additional steps may be employed before, in the middle of, or after the illustrated sequence, but are omitted for clarity.

In some implementations, interferometric modulator devices are provided that can be used in low-power direct-drive segmented displays. The interferometric devices can be manufactured simply and can function in a display without needing to employ hysteresis. The devices can have enhanced robustness to process variation and temperature, and can be manufactured using relatively simple processes, such as printed circuit board (PCB) technology.

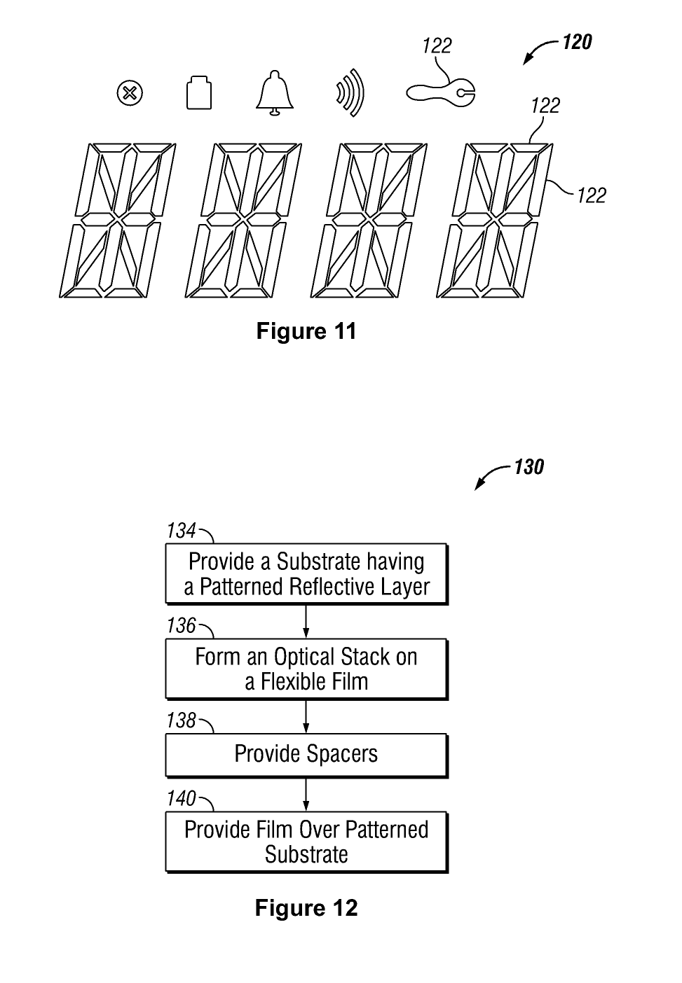

FIG. 11 shows an example of a schematic plan view of a segmented display 120. The segmented display 120 includes segments 122 which can be used to define segmented alphanumeric and graphic characters. The segmented display 120 can include a patterned substrate, such as a PCB, which can be used to in forming images on the display. Segmented displays can be relatively inexpensive to manufacture, and can have reduced dynamic power consumption relative to a comparably sized passive-array, in which significant power can be consumed during row and column switching.

In some implementations described herein, a segmented display is provided that includes a patterned substrate and a flexible film. For example, the patterned substrate can be a printed circuit board (PCB) including segments that operate as stationary electrodes and the flexible film can include an optical stack that has a movable electrode. By controlling the electrical potential between portions of the patterned substrate relative to the flexible film, images can be formed on the segmented display. For example, in some implementations, the flexible film can be held at a fixed electrical potential and the electrical potential of the segments can be selectively controlled to form an image on the segmented display. For instance, generating a relatively large voltage difference between a segment and the flexible film, such as a voltage difference having a magnitude greater that about 5 V, can create an electrostatic force between the flexible film and the segment that can cause a portion of the flexible film over the segment to collapse. Accordingly, the segmented display can be controlled by selectively controlling the electrical potential of the segments relative to the flexible film.

Although one example of a drive scheme for a segmented display was described above, the segmented display can be controlled using any suitable drive scheme. For example, in some implementations, the flexible film can be configured to have a relatively high voltage, such as a voltage greater than or equal to about +5 V, and the segments can be configured to have voltages of about 0 V or about +5 V to control the state of the segmented display. However, in other implementations, the flexible film can be configured to have a relatively low voltage, such as a voltage of about 0 V, and the segments can be configured to have voltages of about 0 V or about +5 V to control the state of the segmented display. Additionally, in some implementations, the segments and/or flexible film can be electrically controlled to negative voltages. For example, the flexible film can be controlled to an electrical potential of about 0 V, segments in an unactuated state can be controlled to an electrical potential of about 0 V, and segments in an actuated state can be alternatively controlled between electrical potentials of about +5 V and about −5 V so as to reduce charge build-up on the flexible film over time.

FIG. 12 shows an example of a flow diagram illustrating a manufacturing process 130 for an interferometric modulator. With reference to FIG. 12, the process 130 starts at block 134, in which a substrate having a patterned reflective layer is provided. In some implementations, the patterned substrate is a PCB having a laminated stack of one or more conducting and non-conducting layers. The non-conducting layers can be, for example, FR-4 board or a ceramic. The conductive layers can include copper or a variety of other suitable metals. A patterned reflective layer, such as Al or aluminized copper, can be provided on the surface layer of the PCB.

The process 130 continues at block 136 with forming an optical stack on a flexible film to produce a flexible interferometric film. The flexible film can include a variety of materials, including, for example polyethylene terephthalate (PET), polyetheretherketone (PEEK), and/or polyimide. The thickness of the flexible film can be selected to achieve a desired flexibility and actuation voltage of the flexible film, as will be described in further detail below. In some implementations, the flexible film has a thickness ranging between about 25 um to about 100 um.

The optical stack can include a transparent conductor, a partially reflective optical absorber layer, and a transparent dielectric. The transparent conductor can be configured as an electrode to pull the flexible film toward the substrate. In some implementations, the transparent conductor includes indium tin oxide (ITO), with a thickness selected to be in the range of about 50 nm to about 100 nm. The absorber layer can include, for example, molybdenum (Mo), chromium (Cr), tungsten (W), vanadium (V), silicon (Si), germanium (Ge), tantalum (Ta), or osmium (Os), and can have, for example, a thickness in the range of about 3 nm to about 20 nm.

The transparent dielectric can include, for example, a silicon dioxide (SiO₂) layer and/or a material having a relatively high index of refraction, such as zirconium (Zr), titanium dioxide (TiO₂), hafnium dioxide (HfO₂), silicon nitride (Si₃N₄), silicon oxynitride (SiON), yttrium oxide (Y₂O₃), gallium nitride (GaN), gallium phosphide (GaP), or nanocrystalline diamond. The index of refraction can be selected to be greater than or equal to about 2.0, or more particularly, greater than or equal to about 2.4. Inclusion of a dielectric having a relatively high index of refraction can increase the brightness of the segmented display when the gap height is selected to be relatively large so that the optically resonant cavity has a plurality of optical resonances in the visible band of light. The thickness of the dielectric can be selected, for example, to be in the range of about 20 nm to about 50 nm.

A flexible interferometric film can be manufactured in a variety of ways. In some implementations, the film is formed using a sheet process. In some other implementations, the film is formed using a roll-to-roll process. In some implementations, the film is formed using blanket depositions, and does not include patterning, thereby reducing manufacturing complexity and cost.

The process 130 continues at block 138, in which spacers are provided. As will be described below, the spacers can be provided to create a gap of an interferometric modulator device through which a mechanical layer moves, thereby changing the reflectance of the interferometric modulator device. In some implementations, the spacers can be positioned in the display region of a segmented interferometric modulator display to support the flexible interferometric film, thereby maintaining a substantially uniform gap between the flexible interferometric film and the patterned reflective layer. The spacers have a density sufficient to support the flexible interferometric film and allow the interferometric modulator film to flex when a desired actuation voltage is applied.

In some implementations, the spacers include discrete spacers positioned across the surface of the substrate. The spacers can include a resin such as polystyrene or an inorganic material such as silicone, glass or sapphire. The diameter of the spacers can be selected to achieve the desired gap height. In some implementations, the diameter of the spacers is greater than about 200 nm. In some other implementations, the diameter of the spacers is selected to be in the range of about 1000 nm to about 1 μm. The spacers also can include other shapes, such as rods or plates. The spacers can be provided using a variety of processes, including, for example, a spray process in which the spacers are randomly scattered to achieve a desired spacer density. In some implementations, the spacer is coated with an adhesive, such as an epoxy.

Spacers also can be integrated into the patterned substrate or the flexible film. In some implementations, spacers are provided using integrated posts, rails and/or other protrusions on the patterned substrate. In some implementations, the flexible film is fabricated having posts, rails, and/or protrusions of any other suitable pattern. For example, the flexible film can be patterned using periodically spaced posts before depositing a conformal optical stack, thereby producing post structures in the resulting interferometric modulator device.

With continuing reference to FIG. 12, the process 130 continues at block 140, in which the flexible film is provided over the patterned substrate to form an interferometric modulator device. In some implementations, the film is machine cut to fit the patterned substrate, and laminated to the patterned substrate. Skilled artisans will appreciate that one or more additional steps can be performed before providing the flexible film over the patterned substrate. For example, a desiccant configured to absorb water molecules that permeate the display package structure once it has been manufactured can be provided. The desiccant can maintain a low humidity environment between the flexible film and the substrate and can prevent water vapor from adversely affecting the operation of the interferometric modulator device. Suitable desiccant materials include, but are not limited to, zeolites, calcium sulfate (CaSO₄), calcium oxide (CaO), silica gel, molecular sieves, surface adsorbents, bulk adsorbents, and/or chemical reactants.

The process above can be used for manufacturing, for example, interferometric modulator devices that can be used in a segmented display, such as the segmented display 120 of FIG. 11. The segmented display can be a direct-drive display in which row and column switching is eliminated, thereby reducing power consumption and avoiding a need to use hysteresis. Furthermore, the segmented display can employ a substrate having a patterned reflective layer, such a PCB, to form an interferometric stack. The resulting interferometric modulator devices can be manufactured inexpensively, and can be tolerant to process, voltage, and/or temperature variation. Additional steps may be employed before, in the middle of, or after the illustrated sequence, but are omitted for clarity.

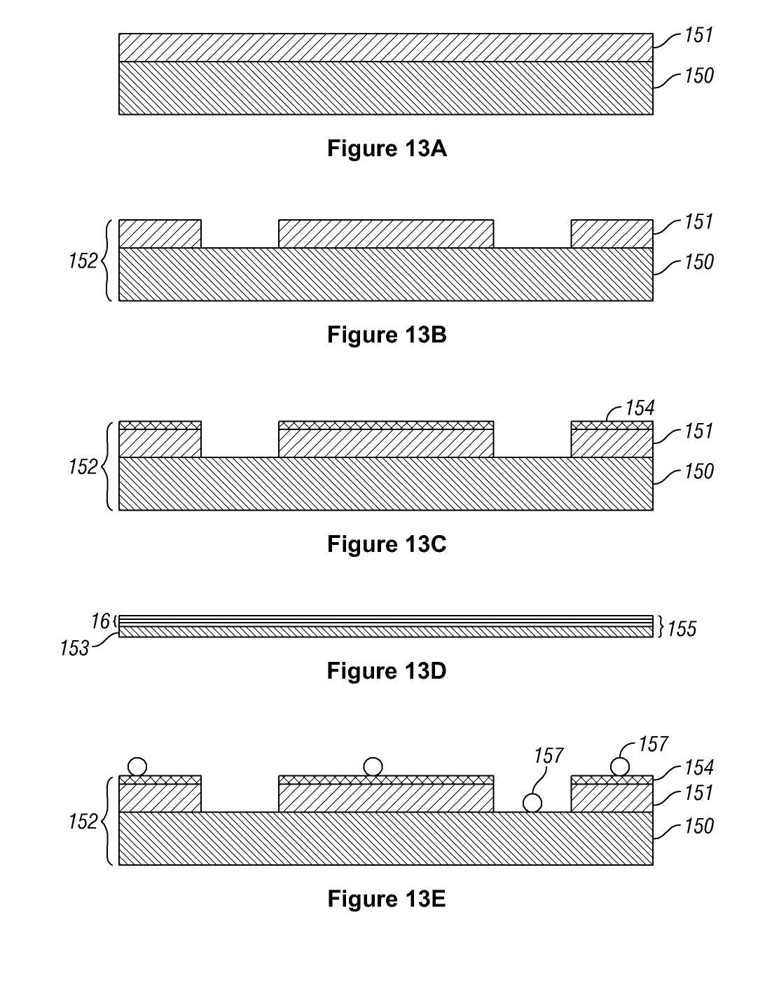

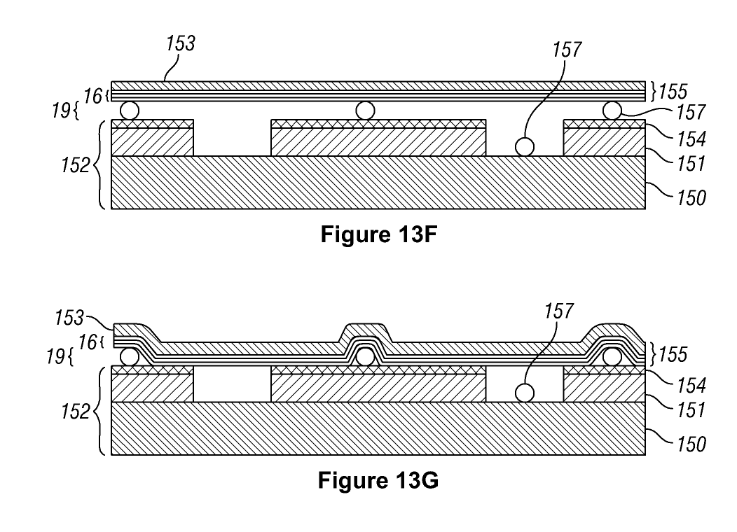

FIGS. 13A-13G show examples of cross-sectional schematic illustrations of various stages in methods of making interferometric modulators according to various implementations.

FIGS. 13A-13C illustrate forming a substrate having a patterned reflective layer. In FIG. 13A, a nonconductive substrate 150 having a conductor 151 has been provided. In some implementations, the nonconductive substrate 150 and a conductor 151 are a blank PCB including a uniform layer of copper (Cu) over a nonconductive substrate, such as FR-4 board.

In FIG. 13B, the conductor 151 has been patterned to form a patterned substrate 152. The conductor 151 can include a plurality of segments and/or symbols selectively arranged in any suitable configuration. Accordingly, the patterned substrate 152 can be employed in a segmented display, such as the segmented display 120 of FIG. 11. The conductor 151 can be patterned using a variety of techniques, including, for example, silk screen printing, photoengraving, and/or milling. Although FIGS. 13A and 13B illustrate patterning the conductor 151 on the nonconductive substrate 150 to form the patterned substrate 152, persons having ordinary skill in the art will appreciate that the patterned substrate 152 can be formed by a variety of other methods, such as by depositing traces on the substrate using electroplating.

In FIG. 13C, a reflector 154 has been formed on the conductor 151. The reflector 154 can include a variety of materials suitable for formation on a conductive surface. In some implementations, the conductor 151 includes Cu and the reflector 154 includes aluminized copper. The aluminized copper reflector can be formed using, for example, an aluminum deposition step followed by a high-temperature anneal. However, skilled artisans will appreciate that a wide variety of method can be employed to form aluminized copper on a copper conductor. In some implementations, the reflector 154 can have a thickness ranging between about 20 nm to about 100 nm.

FIG. 13D illustrates providing a flexible interferometric film 155. As shown in FIG. 13D, the flexible interferometric film 155 includes an optical stack 16 and a flexible film 153. The illustrated optical stack 16 includes a transparent conductor, a partially reflective optical absorber layer, and a transparent dielectric. The flexible interferometric film 155 can be formed, for example, using uniform conformal depositions in a sheet process.

In FIG. 13E, spacers 157 have been provided over the patterned substrate 152 of FIG. 13C. The spacers 157 can be distributed across the surface of the patterned substrate 152, and can be used to define the gap height of an interferometric modulator device, as will be described below. The spacers 157 can be provided using a variety of processes, including, for example, a spray process in which the spacers are randomly scattered to achieve a desired spacer density. The spacers 157 can be coated with an adhesive, such as an epoxy, either before or after being distributed.

Spacers also can be integrated into the patterned substrate or the flexible film, rather than by distributing discrete objects. For example, spacers can be provided using integrated posts, rails and/or other protrusions on the patterned substrate 152. In some implementations, the flexible film 153 is fabricated to have protrusions. For example, the flexible film can be patterned using periodically spaced posts before depositing a conformal optical stack, thereby producing post structures in the film.

FIG. 13F illustrates providing the flexible interferometric film 155 over the patterned substrate 152 to form an interferometric modulator device. The flexible interferometric film 155 can be machine cut to fit the patterned substrate 152, and thereafter the flexible interferometric film 155 and the patterned substrate 152 can be laminated together. Desiccant can be provided before attaching the flexible interferometric film 155, to maintain a low humidity environment in the gap 19 to prevent water vapor from adversely affecting the operation of the interferometric modulator device.

FIGS. 13F and 13G illustrate the interferometric modulator device in the relaxed and actuated positions, respectively. The spacers 157 support the flexible film 153 and the optical stack 16 over a collapsible gap 19. The spacers 157 can be used to define the gap height of the interferometric modulator device. Additionally, the density of the spacers 157 can be used to selectively vary the actuation voltage of the interferometric modulator device, which can be based on the flexibility of the flexible interferometric film 155 and the height of the gap 19. The density of spacers 157 can be varied to control the tension of the flexible interferometric film 155, thereby controlling the actuation voltage of the interferometric modulator device. For example, the density of spacers can be determined by the stiffness of the film. In some implementations, the density of the spaces is in the range of about 1 spacer per 10,000 μm² to about 1 spacer per 1 μm².

The reflective layer 154, the gap 19, and the optical stack 16 form an interferometric stack, such as the interferometric stack 99 of FIG. 9A. A voltage can be applied between the transparent conductor in the optical stack 16 and the conductor 151 to collapse the gap 19 into the actuated position, as shown in FIG. 13G. In some implementations, the gap 19 has a height selected using the spacers 157 to be in the range of about 1000 nm to about 10 μm to form an interferometric modulator device having multiple optical resonances. The multiple optical resonances can be employed to produce reflected light which is substantially white over a relatively wide range of gap sizes. For example, as was described above with reference to FIGS. 8-10, employing an interferometric modulator device having a relatively large gap height can reduce the sensitivity of the interferometric modulator device to gap height variation and temperature, which can permit the use of manufacturing processes having a relatively low precision. These processes can be cheaper than processes designed for smaller tolerances, resulting in a decreased cost for a display employing these interferometric modulators.

The interferometric modulator device of FIGS. 13F and 13G can be used in a segmented display, such as the segmented display 120 of FIG. 11. Although the spacers 157 can result in portions of the interferometric modulator device reflecting an undesired color, the density of the spacers 157 can be relatively low, and the segmented display can have a resolution suitable for a wide variety of applications.

The patterned substrate 152 can be a PCB, and can include vias to allow electrical connection to conductors positioned on the opposite side of the substrate 150. Thus, the patterned substrate 152 can include one or more additional conductive layers used in selectively controlling the voltage provided to the conductive layer 151. By varying the voltage provided to portions of the conductor 151, portions of the flexible interferometric film 155 can be selectively relaxed or actuated, thereby controlling the images displayed on the segmented interferometric display.

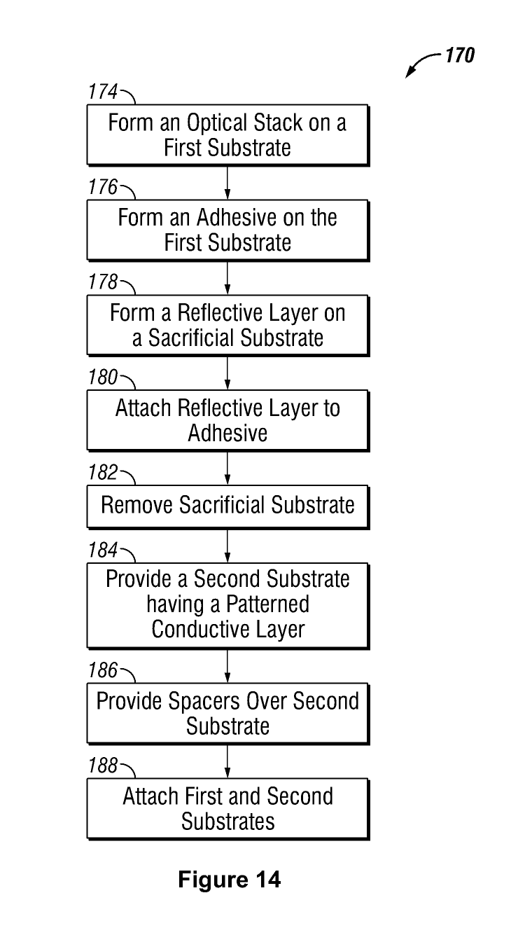

FIG. 14 shows an example of a flow diagram illustrating a manufacturing process 170 for an interferometric modulator. With reference to FIG. 14, the process 170 starts at block 174, in which an optical stack is formed on a first substrate. The first substrate can be, for example, a transparent substrate including plastic, or other transparent bendable substrates. Although the process 170 is illustrated as starting at 172, in some implementations one or more layers are provided before forming the optical stack over the first substrate.

The process 170 continues at block 176, in which an adhesive is formed on the first substrate. The adhesive can be, for example, an epoxy, or any other suitable material. The adhesive can be deposited in a variety of ways, including deposition. The adhesive can have a strength and thickness selected to support a flexible reflective layer, as will be described in further detail below. Additionally, the adhesive can be used to provide a thin gap and to maintain tension for a subsequently attached layer, as will be described in detail below. In some implementations, the adhesive is provided randomly across a surface of the first substrate. However, in some other implementations, the adhesive is selectively provided over particular locations of the first substrate.

The method 170 continues at a block 178, in which a reflective layer is formed on a sacrificial substrate. The sacrificial substrate can be planar, or may be shaped to have a preformed pattern. Preformed patterns may be provided by, for example, embossing, inscribing, or depositing/etching rails and/or posts such that the reflective layer can be discontinuously deposited thereon. The sacrificial substrate can include, for example, silicon (Si), glass, or a plastic. The reflective layer can be, for example, an Al layer. The reflective layer can be formed using any suitable technique, including, for example, photolithography and etching, or screen printing. The thickness of the reflective layer can be selected to vary the actuation voltage of the interferometric modulator device, as will be described below.

One or more additional layers can be provided before or after forming the reflective layer on the sacrificial substrate. In some implementations, a nonconductive layer is provided before forming the reflective layer in order to prevent electrical shorts in the resulting interferometric modulator device.

With continuing reference to FIG. 14, the process 170 continues at block 180, in which the reflective layer is attached to the adhesive. Attaching the reflective layer to the adhesive can include a heating step to aid in curing the adhesive. The method 170 continues at a block 182, in which the sacrificial substrate is removed. Removal of the sacrificial substrate can be performed using a variety of suitable methods, including an etching step.

In a block 184, a second substrate having a patterned conductive layer is provided. In some implementations, the patterned substrate is a printed circuit board (PCB) having a laminated stack of one or more conducting and non-conducting layers. The non-conducting layers can be, for example, FR-4 board or a ceramic. The conductive layers can include Cu and/or a variety of other suitable metals. A patterned conductive layer, such as copper or aluminized copper, can be provided on the surface layer of the PCB.

The process 170 continues at block 186, in which spacers are provided over the second substrate. As will be described below, the spacers can be provided to maintain a gap of an interferometric modulator device. The spacers can be positioned in the display region of a segmented interferometric modulator display to support the movable reflective layer and the optical stack, thereby maintaining a substantially uniform gap between the reflective layer and the second substrate. The spacers can have a density sufficient to support the movable reflective layer and which provides a desired actuation voltage.

In some implementations, the spacers include discrete spacers, such as spherical objects, positioned across the surface of the substrate. Spacers also can be integrated into the second substrate. In some implementations, spacers are provided using integrated posts, rails or other protrusions on the second substrate.

In a block 188, the first and second substrates are attached to form an interferometric modulator. Before attaching the first and second substrates, a desiccant can be provided to maintain a low humidity environment between the first and second substrates and can prevent water vapor from adversely affecting the operation of the interferometric modulator device. Suitable desiccant materials can be as described earlier.

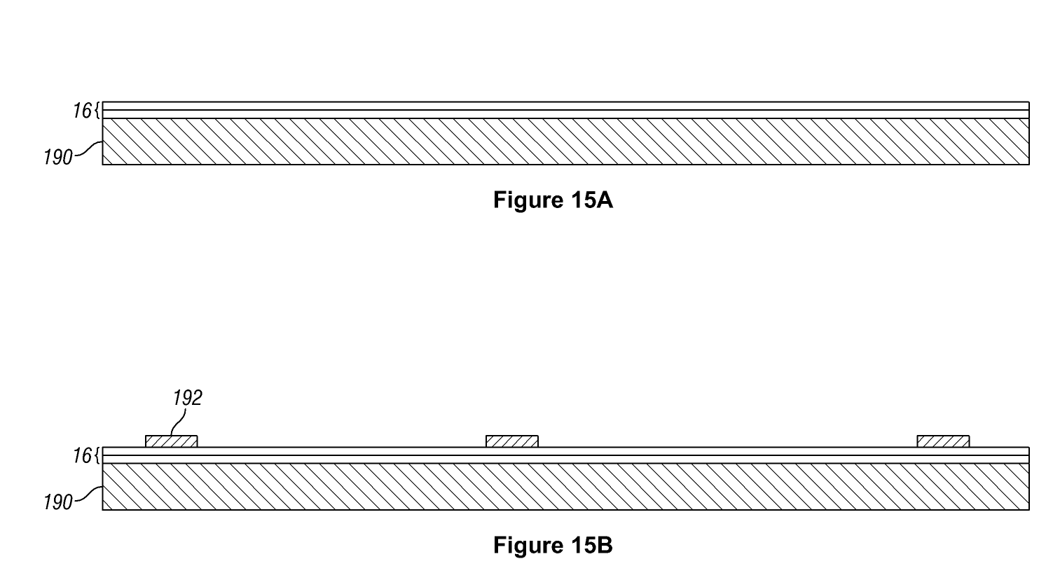

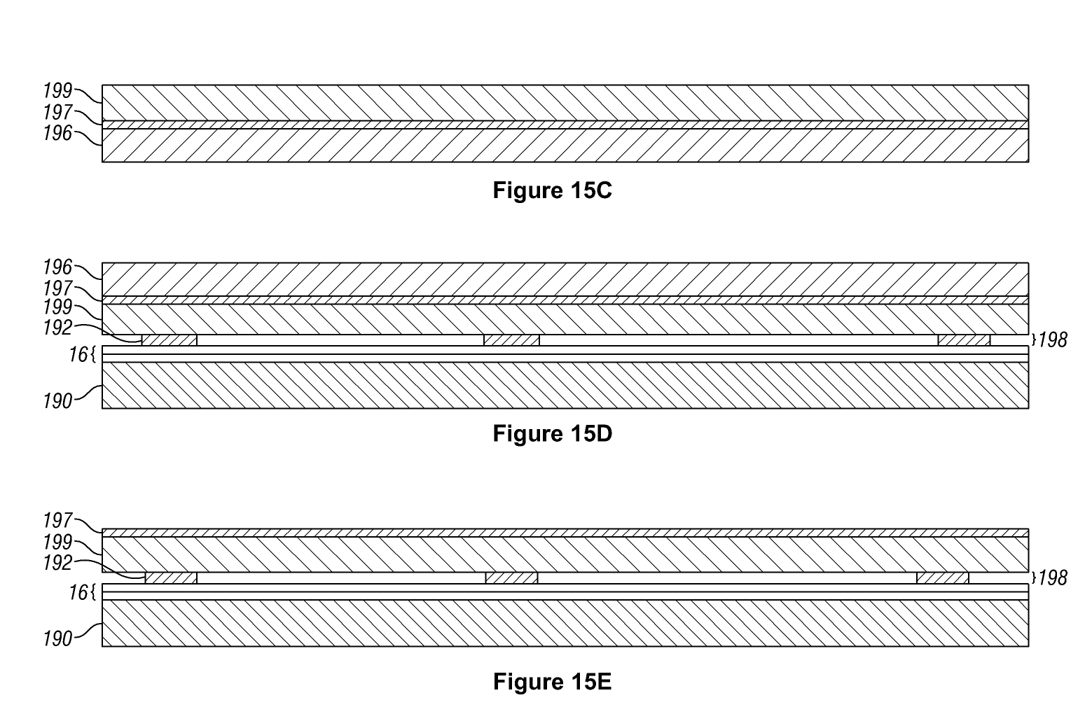

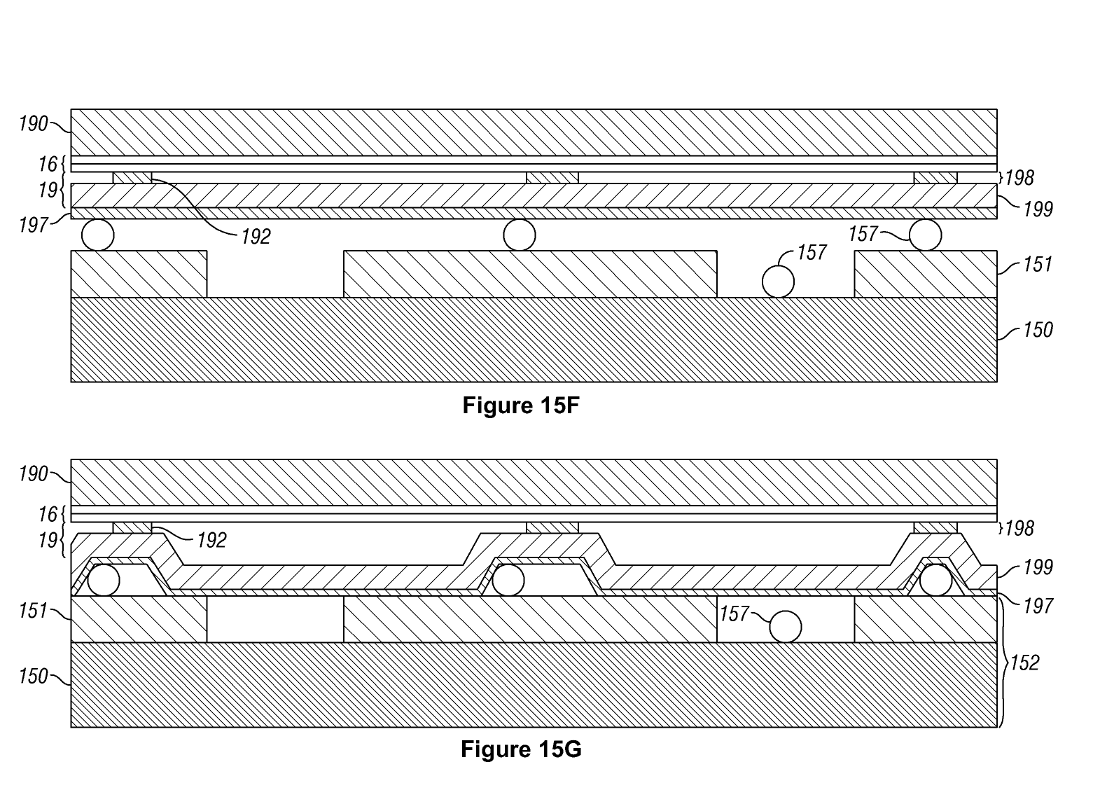

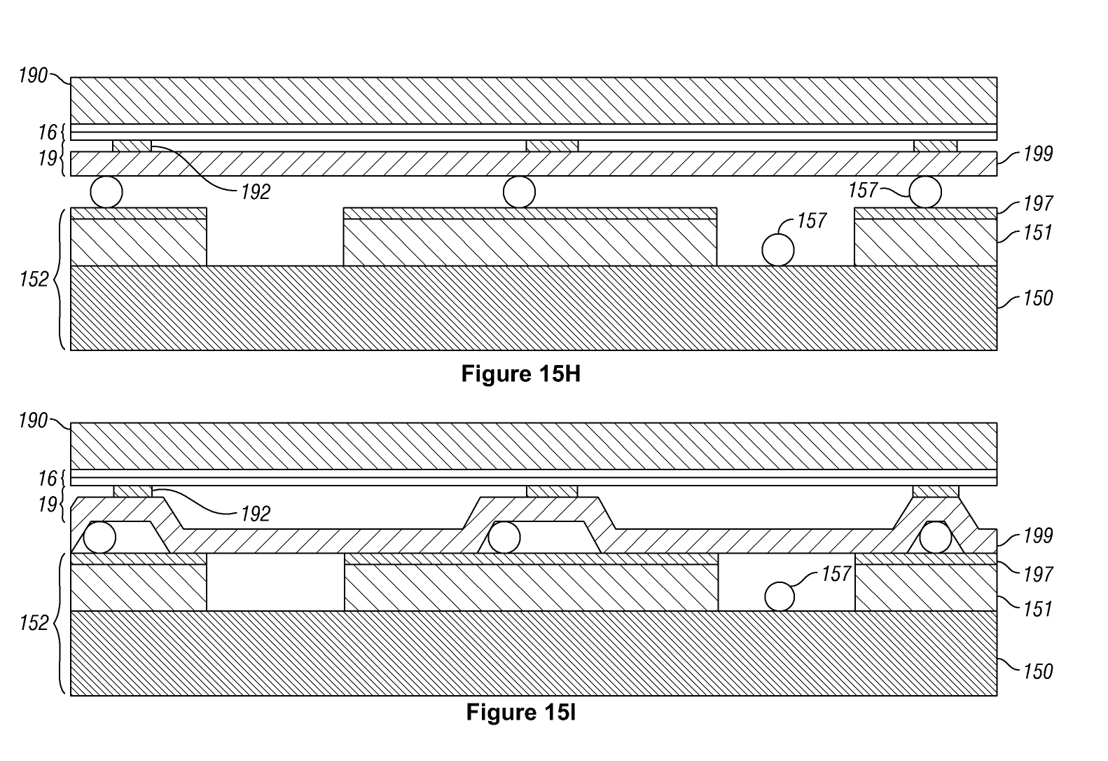

The process 170 above can be used for manufacturing, for example, the interferometric modulators illustrated in FIGS. 15F-15I below. The interferometric modulator devices can be employed in a segmented display, such as the segmented display 120 of FIG. 11. Additional steps may be employed before, in the middle of, or after the illustrated sequence, but are omitted for clarity.

FIGS. 15A-15I show examples of cross-sectional schematic illustrations of various stages in methods of making interferometric modulators according to various implementations. [0108] FIGS. 15A and 15B illustrate providing an optical stack 16 and an adhesive 192 over a first substrate 190. The first substrate 190 can be, for example, a transparent substrate including glass, plastic and/or a film, and the optical stack 16 can include, for example, a partially reflective optical absorber layer, and a transparent dielectric. Although not illustrated, the optical stack also can include an optional transparent conductor.

In FIG. 15C, a nonconductive layer 197 and a reflective layer 199 have been formed over a sacrificial substrate 196. The sacrificial substrate 196 can be planar, as illustrated, or may be shaped to have preformed patterns, such as posts or rails. The reflective layer 199 can include, for example, an Al layer. The thickness of the reflective layer 199 can be selected to aid in achieving a desired actuation voltage of the interferometric modulator device. In FIG. 15C, the nonconductive layer 197 has been provided before forming the reflective layer 199 in order to prevent electrical shorts in the resulting interferometric modulator device, as will be described in further detail below. However, in some implementations, such as those shown in FIGS. 15H and 15I, formation of the nonconductive layer 197 can be omitted and other schemes for preventing electrical shorts can be used.

In FIGS. 15D and 15E, the reflective layer 199 is attached to the adhesive 192, and the sacrificial substrate 196 is removed. As shown in FIG. 15D, after attaching the reflective layer 199 to the adhesive 192, a thin gap 198 can be formed. The thin gap 198 can server to space the reflective layer 199 from the optical stack 16, thereby facilitating subsequent actuation of the reflective layer 199.

In FIG. 15F, the first substrate 190 and the structures disposed thereon have been attached to a patterned substrate 152 having a patterned conductive layer 151 and spacers 157. The resulting interferometric modulator device includes an optical stack 16 and a reflective layer 199 separated by a collapsible gap 19. In FIG. 15F, the interferometric modulator device is shown in the relaxed position. In FIG. 15G, the interferometric modulator device is shown in the actuated position. The nonconductive layer 197 can prevent electrical shorts when the device is actuated. The patterned substrate can be, for example, a PCB. The conductor 151 optionally can be aluminized, as was described above with reference to FIG. 13C.

With reference to FIGS. 15F and 15G, the spacers 157 support the reflective layer 199 and the optical stack 16 over the collapsible gap 19. The spacers 157 can be used to define the gap height of the interferometric modulator device. Additionally, the density of the spacers 157 can be used to selectively vary the actuation voltage that is needed to actuate the interferometric modulator device. For example, the density of the spacers can affect the flexibility of the reflective layer 199, and size or diameter of the spacers can affect the height of the gap 19. In particular, the density of the spacers 157 can be varied to control the tension of reflective layer 199, thereby controlling the actuation voltage of the interferometric modulator device. Additionally, the thickness of the reflective layer 199 can be selected to vary the flexibility of the layer. In some implementations, the density of spacers is selected to be in the range of about 1 spacer per 10,000 μm² to about 1 spacer per 1 μm², and the thickness of the aluminum is selected to be in the range of about 30 nm to about 100 nm.

The reflective layer 199, the gap 19, and the optical stack 16 form an interferometric stack, such as the interferometric stack 99 of FIG. 9A. A voltage can be applied between the reflective layer 199 and the conductor 151 to collapse the gap 19 into the actuated position, as shown in FIG. 15G. In some implementations, the gap 19 has a height selected using the spacers 157 to be in the range of about 1000 nm to about 10 μm to form an interferometric modulator device having multiple optical resonances.

FIGS. 15H and 15I illustrate another example of an interferometric modulator device. In contrast to the interferometric modulator device of FIGS. 15F and 15G, the illustrated interferometric modulator device includes a nonconductive layer 197 formed on the conductor 151 of the patterned substrate 152. The nonconductive layer 197 can aid in preventing electrical shorts between the conductor 151 and the reflective layer 199 when the interferometric modulator device is in the relaxed position. Thus, employing the nonconductive layer 197 on the patterned substrate can remove the need for forming a nonconductive layer on a surface of the reflective layer 199. The nonconductive layer 197 can be formed on the patterned substrate 152 using a variety of techniques, including any suitable coating method.

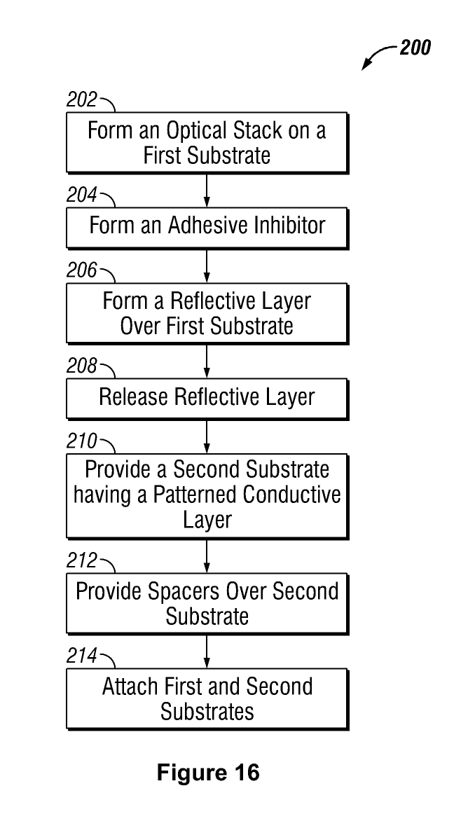

FIG. 16 shows an example of a flow diagram illustrating a manufacturing process 200 for an interferometric modulator. With reference to FIG. 16, the process 200 starts at block 202, in which an optical stack is formed on a first substrate. Details of this step can be as described above with reference to block 174 of FIG. 14.

In a block 204, an adhesive inhibitor is formed on the first substrate. The adhesive inhibitor can include, for example, a material suitable to prevent adhesion of a materially subsequently deposited using physical vapor deposition (PVD) or other deposition processes. The adhesive inhibitor can be uniformly deposited, and then selectively removed to permit a subsequently deposited reflective layer to contact the optical stack.

With continuing reference to FIG. 16, the process 200 continues at block 206, in which a reflective layer is provided over the first substrate and the adhesive inhibitor. Based on the patterning of the adhesive inhibitor, the reflective layer can contact the adhesive inhibitor or the optical stack. Thereafter, the reflective layer can be patterned to produce holes or other perforations to aid in releasing the reflective layer, as will be described below.

The process 200 continues at block 208, in which the reflective layer is released. In some implementations, releasing the reflective layer includes providing a superstructure having an electrode, and applying a voltage between the electrode and the reflective layer. The resulting electrostatic forces can pull the reflective layer away from the first substrate, and can create a thin gap between the reflective layer and the adhesion inhibitor. The reflective layer can include holes or other perforations configured to avoid creating a vacuum when the reflective layer is released.

The process 200 of FIG. 16 continues at block 210, in which a second substrate having a patterned conductive layer is provided. In a block 212, spacers are provided over the second substrate. The process 200 continues at block 214, in which the first and second substrates are attached to form an interferometric modulator. Additional details of blocks 210, 212, 214 can be as described above with reference to blocks 184, 186, 188 of FIG. 14.

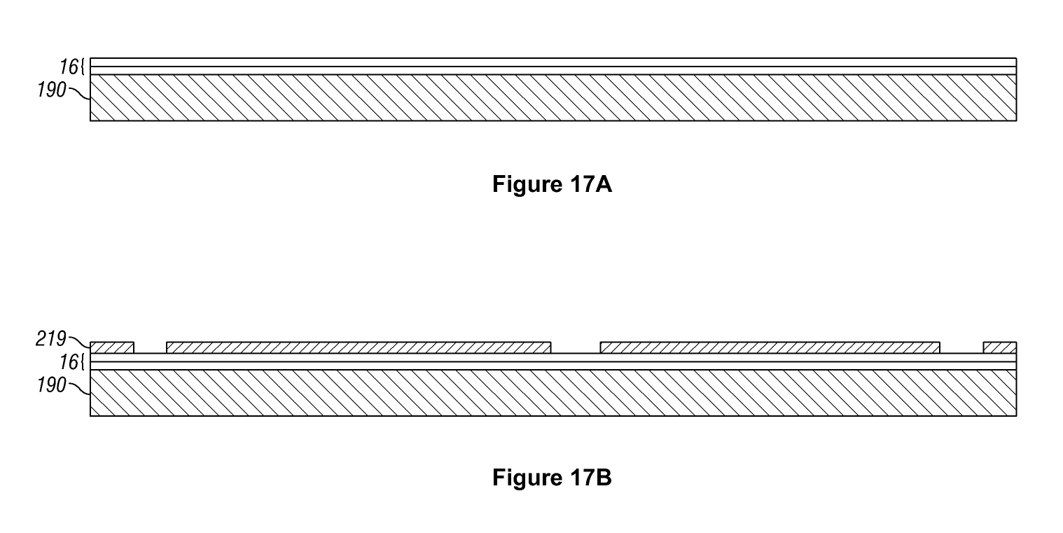

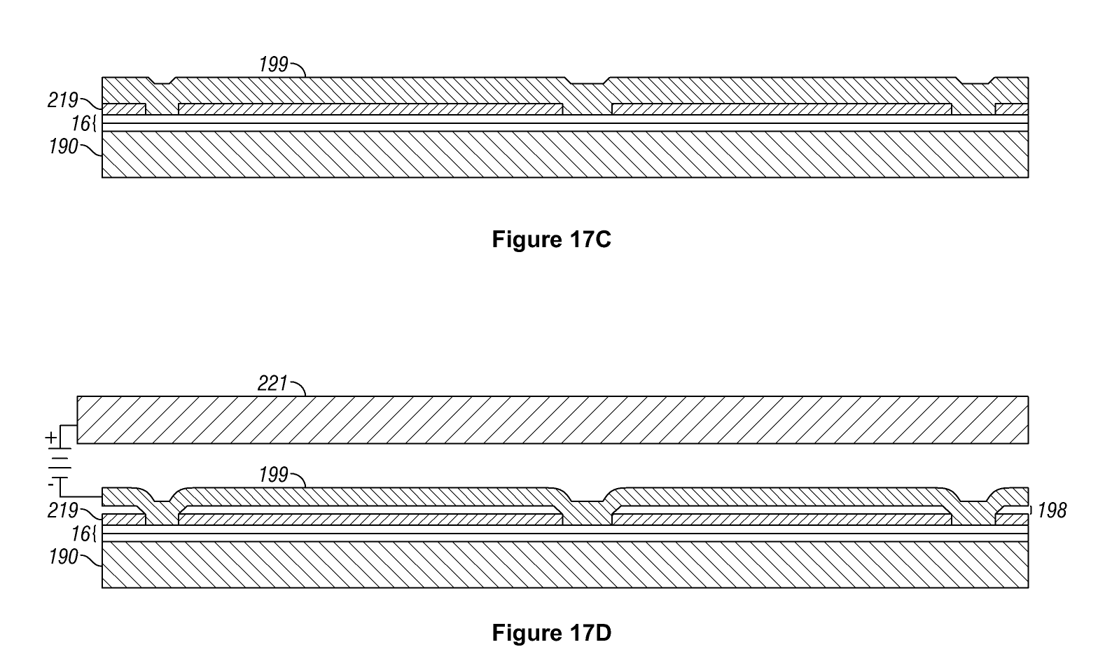

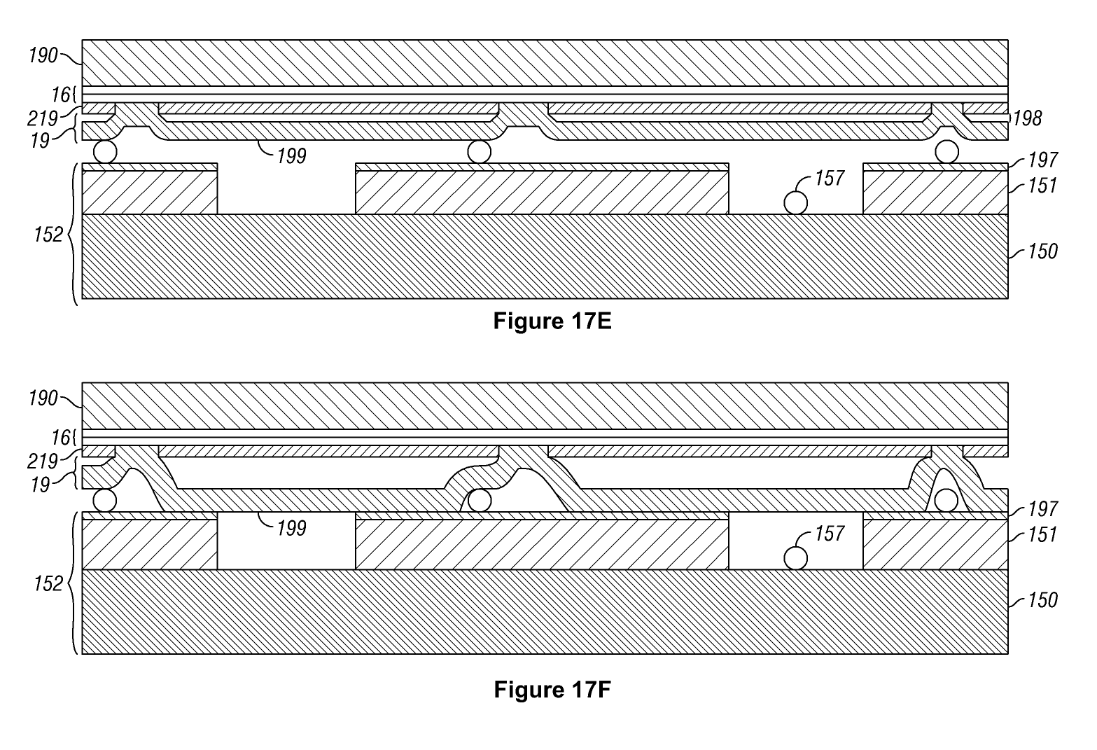

The process 200 above can be used for manufacturing, for example, the interferometric modulators illustrated in FIGS. 17E and 17F below. The interferometric modulator devices can be employed in a segmented display, such as the segmented display 120 of FIG. 11. Additional steps may be employed before, in the middle of, or after the illustrated sequence, but are omitted for clarity.

FIGS. 17A-17F show examples of cross-sectional schematic illustrations of various stages in methods of making interferometric modulators according to various implementations. It will be understood that not all of the illustrated steps are required, and that this method can be modified without departing from the spirit and scope of the invention.

In FIG. 17A, an optical stack 16 has been formed over a first substrate 190. Additional details can be similar to those described above with reference to FIG. 15A. In FIG. 17B, an adhesive inhibitor 219 has been provided over the first substrate 190 and the optical stack 16. The adhesive inhibitor 219 can be patterned to permit a subsequently deposited layer to selectively contact the optical stack 16. The adhesive inhibitor 219 can be optically transparent and can be configured to prevent adhesion of a subsequently deposited layer. The adhesive inhibitor can be deposited using any suitable deposition technique, can be selectively patterned using, for example, an etching or micromachining processes.

In FIG. 17C, a reflective layer 199 has been provided over the adhesive inhibitor 219 and the first substrate 190. The reflective layer 199 can be deposited using a variety of suitable processes, and can include, for example, Al. Additional details of the reflective layer 199 can be as described above with reference to FIGS. 14-16. After the reflective layer 199 is provided, the reflective layer can be patterned with holes or other perforations to aid in preventing the formation of a vacuum when the reflective layer is subsequently released, as will be described below.

FIG. 17D illustrates providing a superstructure 221 over the first substrate 190. A voltage can be applied between the superstructure 221 and the reflective layer 199. The applied voltage can generate electrostatic forces which can pull the reflective layer 199 away from the adhesive inhibitor 219 to define a thin gap 198. The thin gap 198 can server to space the reflective layer 199 from the first substrate 190, thereby facilitating subsequent actuation of the reflective layer 199. In some implementations, the thin gap 198 has a height in the range of about 50 nm to about 1,000 nm.

After release of the reflective layer 199, the first substrate 190 and the structures formed thereon can be attached to a patterned substrate 152. The attachment process and particular configurations of the patterned substrate 152 can be as described above with reference to FIGS. 13F and 15F.

The resulting interferometric modulator is shown in the relaxed and actuated positions in FIGS. 17E and 17F, respectively. As illustrated, the spacers 157 support the reflective layer 199 and the optical stack 16 over the collapsible gap 19. The spacers 157 can be used to define the gap height of the interferometric modulator device, and the density of the spacers 157 can be used to selectively vary the actuation voltage of the interferometric modulator device, as described above with reference to FIGS. 15F and 15G. The reflective layer 199, the gap 19, and the optical stack 16 form an interferometric stack, such as the interferometric stack 99 of FIG. 9A. A voltage can be applied between the reflective layer 199 and the conductor 151 to move the reflective layer 199 into the actuated position, as shown in FIG. 15G. A nonconductive layer 197 can be prevented to prevent electrical shorts when the interferometric modulator device is actuated. However, skilled artisans will appreciate that the nonconductive layer can be omitted in favor of using, for example, a nonconductive layer on the reflective layer 197.

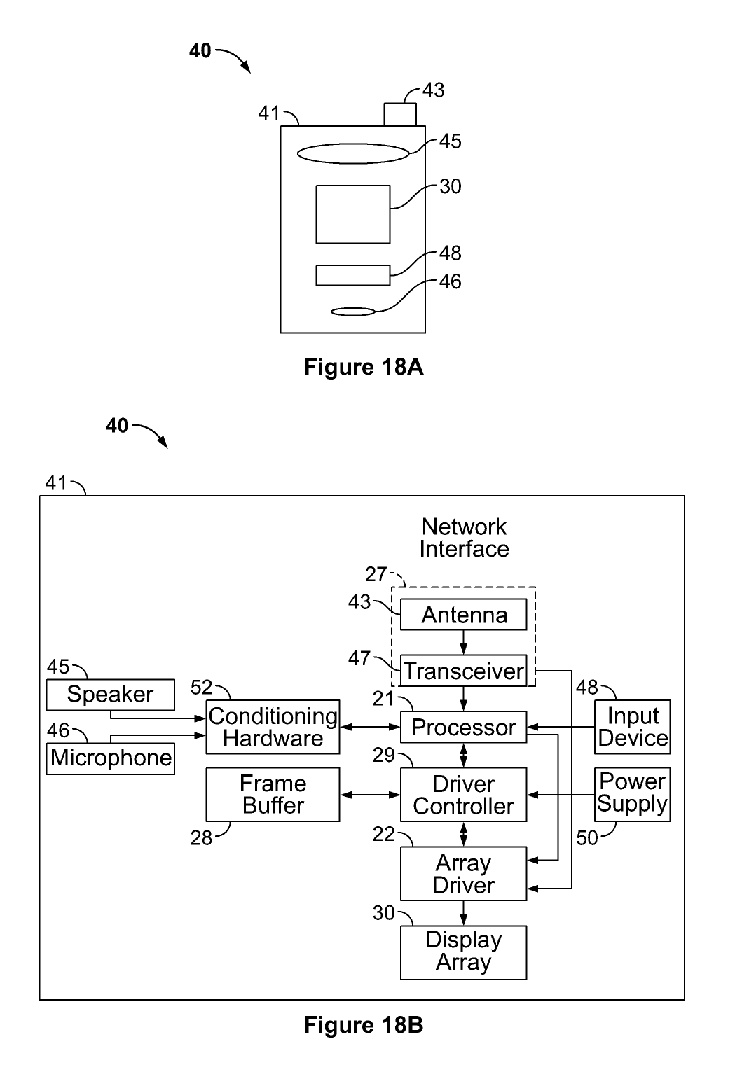

FIGS. 18A and 18B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 18B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a plurality of display elements, each element including
a conductive element;
a flexible film including a partially reflective and partially transmissive absorber layer; and
a reflective layer disposed on the conductive element, the reflective layer disposed at least partially between the flexible film and the conductive element,
wherein the reflective layer and the absorber layer define a cavity therebetween and wherein the flexible film is configured to move toward the conductive element when a voltage is applied across the flexible film and the conductive element due to an electrostatic force generated between the flexible film and the conductive element.

2. The device of claim 1, wherein the absorber layer has a thickness dimension that is between about 3 nm and about 20 nm.

3. The device of claim 1, wherein the flexible film further includes a dielectric layer.

4. The device of claim 3, wherein the dielectric layer has a thickness dimension that is between about 20 nm and about 50 nm.

5. The device of claim 3, wherein the dielectric layer is disposed between the absorber layer and the reflective layer.

6. The device of claim 5, wherein the dielectric layer is connected to the absorber layer.

7. The device of claim 3, wherein the dielectric layer includes at least one of zirconium dioxide (ZrO₂), titanium dioxide (TiO₂), hafnium dioxide (HfO₂), silicon nitride (Si₃N₄), silicon oxynitride (SiON), yttrium oxide (Y₂O₃), gallium nitride (GaN), gallium phosphide (GaP), and nanocrystalline diamond.

8. The device of claim 3, wherein the dielectric layer includes a material having an index of refraction greater than about 2.0.

9. The device of claim 8, wherein the dielectric layer includes a material having an index of refraction greater than about 2.4.

10. The device of claim 1, wherein the cavity has a height ranging between about 1 μm and about 10 μm.

11. The device of claim 1, wherein the cavity is configured to produce a plurality of reflectivity spectrum peak wavelengths.

12. The device of claim 1, wherein the absorber layer includes at least one of molybdenum (Mo), chromium (Cr), tungsten (W), vanadium (V), silicon (Si), germanium (Ge), tantalum (Ta), and osmium (Os).

13. The device of claim 1, wherein the display device further includes a printed circuit board, and wherein the printed circuit board includes the conductive element.

14. The device of claim 13, wherein the conductive element includes a copper (Cu) trace.

15. The device of claim 14, wherein the reflective layer includes an aluminized copper coating of the copper trace.

16. The device of claim 1, wherein a surface of the conductive element adjacent to the reflective layer is non-planar.

17. The device of claim 1, wherein the reflective layer includes aluminum (Al).

18. The device of claim 1, further comprising:
a processor that is configured to communicate with the conductive element, the processor being configured to process image data; and
a memory device that is configured to communicate with the processor.

19. The device of claim 18, further comprising:
a driver circuit configured to send at least one signal to the conductive element; and
a controller configured to send at least a portion of the image data to the driver circuit.

20. The device of claim 18, further comprising an image source module configured to send the image data to the processor.

21. The device of claim 20, wherein the image source module includes at least one of a receiver, transceiver, and transmitter.

22. The device of claim 18, further comprising an input device configured to receive input data and to communicate the input data to the processor.

23. The device of claim 1, further comprising spacing elements disposed between the flexible film and the conductive element.

24. The device of claim 23, wherein the spacing elements include glass or sapphire.

25. The device of claim 1, further comprising a substrate layer, wherein the flexible film is disposed between the substrate layer and the reflective layer, wherein the flexible film is fixedly attached to the substrate layer at a plurality of points, and wherein at least a portion of the flexible film is configured to move away from the substrate when a voltage is applied between the absorber layer and the conductive element.

26. A device comprising
a flexible absorber layer, wherein the absorber layer is partially reflective and partially transmissive;
a printed circuit board including at least one conductive trace element; and
a reflective layer disposed over the conductive trace element,
wherein the flexible absorber layer is configured to move toward the printed circuit board when a voltage is applied between the absorber layer the conductive trace element, and wherein movement of the absorber layer alters the optical characteristics of the display device.

27. The device of claim 26, wherein the absorber layer includes molybdenum (Mo).

28. The device of claim 27, further comprising a dielectric layer disposed between the absorber layer and the reflective layer.

29. The device of claim 28, wherein the dielectric layer includes zirconium dioxide (ZrO₂).

30. The device of claim 26, further comprising a plurality of spacing elements disposed between the absorber layer and the printed circuit board.

31. The device of claim 26, wherein the dielectric layer includes a material having an index of refraction greater than about 2.0.

32. The device of claim 26, wherein the absorber layer and the printed circuit board are separated by a gap having a height in the range of about 1 μm and about 10 μm.

33. A device comprising:
display means including
means for applying a voltage;
flexible means for partially reflecting and transmitting light; and
means for reflecting light disposed on the voltage applying means,
wherein the reflective means is disposed at least partially between the flexible means and the voltage applying means,
wherein the reflective means and the flexible means define a cavity therebetween and wherein the flexible means is configured to move toward the voltage applying means when a voltage is applied between the flexible means and the voltage applying means.

34. The device of claim 33, wherein the voltage applying means includes a printed circuit board.

35. The device of claim 33, wherein reflecting means includes a layer of aluminum (Al).

36. The device of claim 33, wherein the flexible means includes a layer of molybdenum (Mo).

37. A method of manufacturing a device, comprising:
depositing an absorber layer on a sacrificial material, wherein the absorber layer includes a partially reflective and transmissive material;
providing a substrate;
depositing a first adhesive layer on the substrate;
depositing a second adhesive layer on the substrate, wherein the first adhesive layer and the second adhesive layer are substantially co-planar and are spaced apart from one another on a common plane;
positioning the absorber layer over the first and second adhesive layers such that the absorber layer contacts the first and second adhesive layers; and
developing the adhesive layer.

38. The method of claim 37, further comprising:
providing a conductive element;
depositing a reflective layer over at least a portion of the conductive element;
depositing a plurality of spacing elements over the conductive element; and
disposing the absorber layer and substrate over the conductive element such that the absorber layer is disposed between the substrate and the spacing elements.

39. The method of claim 38, wherein the spacing elements include glass or sapphire.

40. The method of claim 38, wherein the conductive element includes a printed circuit board.

41. The method of claim 37, further comprising removing the sacrificial substrate.

42. The method of claim 37, wherein the spacing elements have a height in the range of about 1 μm and about 10 μm.

43. The method of claim 37, further comprising providing a dielectric layer adjacent the absorber layer.

44. The method of claim 43, wherein the dielectric layer includes a material having an index of refraction greater than about 2.0.

45. A method of manufacturing a device, the method comprising:
providing a substrate;
depositing an adhesive inhibiting material on the substrate;
depositing an absorber layer over the adhesive inhibiting material, wherein the absorber layer includes a partially reflective and transmissive material;
providing an electrode; and
applying a voltage between the absorber layer and the electrode to pull a portion of the absorber layer away from the substrate.

46. The method of claim 45, wherein the adhesive inhibiting material is deposited using physical vapor deposition.

47. The method of claim 45, further comprising removing the electrode.

48. The method of claim 45, further comprising:
providing a conductive element;
depositing a reflective layer over at least a portion of the conductive element;
depositing a plurality of spacing elements over the conductive element; and
disposing the absorber layer and substrate over the conductive element such that the absorber layer is disposed between the substrate and the spacing elements.

49. The method of claim 45, further comprising removing the adhesive inhibiting material between the substrate and the portion of the absorber that is pulled away from the substrate.
